(19) United States
(12) Patent Application Publication
(10) Pub. No.: US 2026/0267969 A1
(43) Pub. Date: Sep. 10, 2026

(54) Methods and Systems for Suspected Threat Prioritization and Remediation

(71) Applicant: Veriti Security LTD., Tel Aviv (IL)

(72) Inventors: David ZILBERBERG, Petah Tikva (IL); Ido NITSAN, Tel Aviv (IL); Oren KOREN, Petah Tikva (IL); Adi IKAN, Ra'anana (IL)

(21) Appl. No.: 19/328,168

(22) Filed: Sep. 14, 2025

Related U.S. Application Data
(60) Provisional application No. 63/769,088, filed on Mar. 9, 2025.

(51) Int. Cl. G06F 21/55

(52) U.S. Cl. CPC G06F 21/554; G06F 2221/034

(57) ABSTRACT

A computer-implemented method determines remediations. Security data that represents a suspected threat to a client is obtained, and a plurality of technical features are extracted from the security data. A first machine learning model classifies an authenticity of the suspected threat based on the technical features, and a second machine learning model estimates the impact on the client of addressing the suspected threat based on the same features. A third machine learning model then determines a remediation for the suspected threat based on the authenticity classification and the estimated impact.

### CROSS-REFERENCE TO RELATED APPLICATIONS

This application claims priority from U.S. Provisional Patent Application No. 63/769,088, filed Mar. 9, 2025, whose disclosure is incorporated by reference in its entirety herein.

### TECHNICAL FIELD

The present disclosure relates to cybersecurity and, more particularly, but not exclusively, to incorporating impact evaluations in security log analyses.

### BACKGROUND OF THE DISCLOSURE

The increasing complexity of cybersecurity threats necessitates robust security log analysis to detect, assess, and respond to potential risks effectively. Security logs generated by various systems capture critical information about network activity, authentication attempts, system changes, and potential security incidents.

In some cases, clients may employ one or more security measures to protect their digital assets, their software infrastructure, or the like. For example, clients may employ security systems such as firewalls, AntiBot software, AntiVirus software, Intrusion Prevention Systems (IPS), intrusion detection systems, Security Information and Event Management (SIEMs), Automatic Detection and Response (ADR) systems, or the like. However, the application of the security systems by clients may be suboptimal in certain areas. For example, security systems may typically experience a high rate of false positives, where benign events are mistakenly flagged as threats and may be blocked. This can lead to alert overload, consuming the resources of security teams. Additionally, blocking benign threats may adversely affect the performance of client systems. Furthermore, conventional techniques employing classifications that focus on classifying security logs as true positives or false positives, without taking into account the impact of the suspected threat on the client, may be suboptimal. The same suspected threat may have a different impact on different clients, for example, based on which security systems are used by the clients to address the threat. For example, blocking a threat might be crucial for one client's digital assets while having little effect on the digital assets of another client. Additionally, blocking a suspected threat may compromise the core value of a first digital asset, while having little impact on a second digital asset.

### SUMMARY OF THE DISCLOSURE

The present disclosed subject matter, also referred to herein as the disclosure, includes systems, methods, and computer program products for, among other things, determining remediations for suspected threats.

Certain aspects of the present disclosure provide enhanced performance of security systems of clients using a security logs analysis. In some exemplary embodiments, security logs generated by third-party security systems may be obtained, processed, and analyzed, as part of the security logs analysis. For example, the security logs analysis may be performed by an analysis platform that is cloud-based, server-based, or the like.

In certain exemplary embodiments, at a pre-processing stage, the security logs analysis may process and aggregate the security logs from the security systems, to identify suspected threats that were detected and addressed by the security systems. For example, the security systems may address suspected threats by blocking them, reporting them, blocking associated communications, blocking associated ports, or the like.

According to certain exemplary embodiments, for each suspected threat that is extracted from the security logs, the analysis may examine the suspected threat from two distinct but complementary perspectives: evaluating the potential impact of the suspected threat on the client and determining the authenticity of the suspected threat.

In certain exemplary embodiments, the security logs analysis may leverage a number of different supervised or semi-supervised models, such as Artificial Intelligence (AI) models, Machine Leaming (ML) models, or the like. In some exemplary embodiments, each of the models employed by the security logs analysis may comprise an ensemble of one or more machine learning models, machine learning algorithms, deep neural networks, neural network models, regression models, classification models, Reinforcement Learning (RL) models, or the like. For example, a regression model may utilize techniques such as linear regression, polynomial regression, ridge regression, elastic net regression, support vector regression, or the like. In other cases, any other techniques may be utilized, such as heuristic algorithms, gradient boosting techniques, random forest learning, or the like.

According to certain exemplary embodiments, each model may be exploited, utilized, finetuned, or the like, for a different task. For example, a first model (an authenticity model) may be tasked with classifying a suspected threat as authentic or not, and a second model (an impact model) may be tasked with scoring an impact of each suspected threat. In some exemplary embodiments, a third model (an analyzer model) may be tasked with making a decision based on the first and second model outputs, and implementing a feedback loop to enhance the decisions according to user feedback.

In certain exemplary embodiments, the authenticity model may comprise an ensemble of one or more classification models, configured to predict whether a suspected threat is a valid threat or a benign event. For example, the authenticity model may classify a suspected threat of a client based on the security logs of the client that reflect the suspected threat, the countermeasures taken by the security systems in response to the suspected threat, or the like. In some exemplary embodiments, the authenticity model may be configured to output a probability vector for one or more predefined classes, such as a false positive class, a true positive class, an unknown class, a scanner class, or the like.

According to certain exemplary embodiments, the impact model may comprise an ensemble of one or more regression models, configured to score or evaluate an impact of blocking a suspected threat on a client. In some exemplary embodiments, the impact model may be trained to score an estimated impact of addressing the suspected threat, on the client. For example, the impact may be estimated with respect to critical client processes, to client assets, to business workflows of the client, or the like.

In certain exemplary embodiments, the analyzer model may comprise an ensemble of one or more RL models, configured to obtain outputs from the authenticity and impact models, and determine based thereon a priority score of the suspected threat. In case of a significant score, such as a score greater than a threshold, the analyzer model may determine a remediation for the suspected threat. For example, the remediation may comprise blocking the suspected threat, releasing a blocking of the suspected threat, or the like. In some exemplary embodiments, the RL models may be configured to implement a feedback loop in order to tailor the authenticity and impact models specifically to the client's preferences through active learning training.

According to certain exemplary embodiments, the analyzer model may process the outputs of the authenticity and impact models using active learning training, predefined business logic, heuristics, or the like. For example, the analyzer model may obtain an impact score of the suspected threat from the impact model, and a classification of the authenticity of the suspected threat from the authenticity model.

In certain exemplary embodiments, the analyzer model may apply one or more weights on the outputs of the authenticity and impact models, such as to obtain a weighted average of the classification result and of the impact score. In some exemplary embodiments, based on the weighted average, the analyzer model may determine the priority score of the suspected threat.

According to certain exemplary embodiments, one or more remediations may be determined for high priority suspected threats, such as blocking the suspected threat, releasing a blocking that was performed by the security systems, or the like. In some exemplary embodiments, the determined remediation may be provided in the form of generated reports regarding high priority suspected threats, automated alerts indicating the most critical issues, automatic remediations such as automatic changes of settings on client devices, recommendations to adjust the settings, or the like. For example, in case of automatic remediations, a frontend software agent may be executed on client devices and may adjust the settings of the client devices automatically. According to this example, the software agent may comprise a browser extension, a Software Development Kit (SDK), a desktop agent, a mobile application, or any other entity that is capable of adjusting client device settings.

In certain exemplary embodiments, the analyzer model may determine the remediations for the suspected threat based on one or more client preferences, obtained in the form of business logic, rules, or the like. For example, a client may adjust settings of the analyzer model (via a user interface) to determine to block all suspected threats that their priority score is greater than a certain threshold. According to this example, different clients may have different thresholds, resulting in different recommended remediations. As another example, a client may adjust settings of the analyzer model to allow the flow of all internal communications, and prevent blockage thereof. In other cases, any other rules, settings, customizations, or the like, may be set by each client.

According to certain exemplary embodiments, the analyzer model may be configured to improve its decisions over time, such as its priority scores and remediations, according to client preferences of each client. In some exemplary embodiments, the client preferences may be provided as part of a feedback loop of the analyzer model, in order to tailor the authenticity and impact models specifically to the client through active learning training. Within the realm of Reinforcement Learning (RL), the analyzer model may be a type of reinforcement learning model that learns by interacting with users and receiving user feedback, as rewards or penalties, based on its actions. For example, users may grade decisions made by the analyzer model, confirm them or reject them, score them, or the like. According to this example, the user feedback may be used by the analyzer model, over time, to learn an optimal policy that maximizes cumulative rewards over time.

In certain exemplary embodiments, the analyzer model may be used to adjust the policy or Q-values (which represent expected future rewards) that guide the behavior of the authenticity and impact models, based on the user feedback received from users, thereby forming an effective feedback loop. In some exemplary embodiments, the analyzer model may act as a meta-controller that learns how to propagate user feedback to the authenticity and impact models in a way that optimizes their performance according to user preferences. For example, if the user's feedback indicates the decision of the analyzer model to block or release a data flow was proper, the RL model may adjust the policy of the authenticity and impact models to favor actions that led to this positive feedback, and vice versa. Through this feedback loop, the analyzer model may adjust the learning strategies of the authenticity and impact models, influencing how they evolve based on user interaction.

For example, a Q-learning rule may be defined to enable the analyzer model to learn from user feedback, as follows:

$$Q ( {s}_{t + 1} , {a}_{t + 1} ) ← Q ( {s}_{t} , {a}_{t} ) + α ( {r}_{t} + γ {max}_{á} Q ( {S}_{t + 1} , á ) - Q ( {S}_{t} , {a}_{t} ) ) \qquad ( 1 )$$

where sₜ represents the current security status, aₜ refers to the remediation action, rₜ is a reward that reflects user feedback, Q(Sₜ, aₜ) represents the expected total reward for taking action aₜ in state Sₜ, α is the learning rate, and

$${max}_{á} Q ( {S}_{t + 1} , á )$$

represents the best possible future reward the model can achieve from state Sₜ₊₁.

Certain aspects of the present disclosure provide integration of a business impact evaluation within a security log analysis, and further provides assessment of whether or not security countermeasures taken by security systems of a client were optimal for the client or whether their configurations should be adjusted.

Another aspect of the present disclosure provides automatic customizing of the security logs analysis to each client, using the automatic feedback loop. For example, by implementing active learning training, the security logs analysis may be trained to adhere to the preferences of each client.

A further aspect of the present disclosure provides alignment of security countermeasures with key business objectives and budgets, thereby enabling security teams to perform strategic decision-making.

Yet another aspect of the present disclosure provides prioritization of alerts regarding suspected threats according to both the business impact evaluation and the estimated authenticity of the suspected threat, thereby reducing the workload of security analysts and the efficiency of threat management. For example, instead of alerting a client regarding all detected events deemed authentic threats, the disclosed subject matter may only alert the client regarding such threats if their business impact is deemed significant by the analyzer model, if the business impact complies with a client-specific threshold, or the like.

A further aspect of the present disclosure provides refinement of threat detection capabilities, to ensure analysts can act on genuine threats quickly with reduced alert fatigue. For example, by alerting analysts only in cases of high business impact, the analysts can direct their resources towards addressing genuine high-impact threats.

Another aspect of the present disclosure provides organizations the ability to focus on threats with the highest operational or financial stakes, thereby enhancing posture management and making it proactive. The disclosed subject matter enables clients to direct their resources toward the most pressing threats or security exposures that have a highest business impact.

Yet another aspect of the present disclosure provides real-time or near real-time recommendations for handling active breaches. In some exemplary embodiments, basing the identification of suspected threats on security logs that are accumulated in real time, enables clients to find and address active security breaches in real time, e.g., as part of an Automatic Incident Response (AIR) system of the client. For example, clients may obtain in near real time a recommendation to adjust a setting of a security system, for a suspected threat was reflected in accumulated security logs.

A further aspect of the present disclosure provides automation of threat classifications such as the security logs analysis, by leveraging artificial intelligence and machine learning techniques to reduce false positives, identify genuine threats, and assess potential financial or operational ramifications of each threat, thereby aiding security teams in prioritizing responses.

Yet another aspect of the present disclosure provides an enhanced human-machine interface. For example, by taking into account impacts of suspected threats and suggesting remediations, the disclosed subject matter provides users with real-time, context-aware recommendations that streamlines decision-making processes. The cognitive load required from users may be reduced, enabling them to focus on critical tasks while ensuring the security of their systems. The interface of the analysis platform may allow seamless interaction with the generated threat classifications, allowing users to accept, modify, or reject proposed remediations with minimal disruption.

Embodiments of the present disclosure are directed to a computer-implemented method for determining remediations for suspected threats. The method comprises: obtaining security data representing a suspected threat to a client; extracting a plurality of technical features for the suspected threat from the security data; classifying, by a first trained machine learning model, an authenticity of the suspected threat based on the plurality of technical features; estimating, by a second trained machine learning model, an impact on the client of addressing the suspected threat based on the plurality of extracted technical features; and determining, by a third trained machine learning model, a remediation for the suspected threat based on the authenticity classification and the estimated impact.

Optionally, the plurality of technical features includes a Direction of Connection feature.

Optionally, the Direction of Connection feature is determined by generating a topology of digital assets of the client.

Optionally, the plurality of technical features includes at least one of: a Protection Confidence parameter, a Protection Severity parameter, a Number of Logs with a same direction-protection combination, a Number of Unique Destination IPs for a same direction-protection combination, a Mean Time Deltas between consecutive logs, a Standard Deviation of Time Deltas between consecutive logs, or a Percentage of Outliers in time deltas.

Optionally, the Mean Time Deltas between consecutive logs is calculated by dividing a sum of time differences between consecutive logs by a number of logs.

Optionally, the plurality of technical features includes a Standard Deviation of Time Deltas between consecutive logs and a Percentage of Outliers in time deltas.

Optionally, the security data is obtained from one or more security systems of the client, the one or more security systems including at least one of an Intrusion Prevention System (IPS), a firewall, an AntiBot system, an AntiVirus system, or a Security Information and Event Management (SIEM) system.

Optionally, obtaining the security data includes aggregating security logs of the client into events.

Optionally, the method further comprises: processing the obtained security data to identify the suspected threat, and extracting the plurality of technical features for the suspected threat is performed on the processed security data.

Optionally, the third trained machine learning model is configured to apply one or more weights on the authenticity classification and the estimated impact.

Optionally, the first trained machine learning model is a classifier that provides an authenticity classification as a probability vector.

Optionally, the second trained machine learning model is a regression model that provides the estimated impact as a normalized score.

Optionally, the first trained machine learning model is trained using a labeled dataset of events labeled as legitimate attacks or as benign events.

Optionally, the second trained machine learning model is trained using one or more of: a labeled dataset of events labeled as legitimate attacks or as benign events, extracted technical features from suspected threats, configuration files of clients, values of digital assets, remediation costs, downtime consequences, or a number of affected devices.

Optionally, the method further comprises: receiving feedback from the client and tailoring at least one of the trained machine learning models based on the feedback.

Optionally, the remediation comprises one of blocking the suspected threat or releasing a blocking of the suspected threat.

Optionally, the method further comprises: generating an alert or a report, and the remediation is incorporated into the alert or report.

Optionally, the third trained machine learning model determines a priority score for the suspected threat based on the authenticity classification and the estimated impact.

Embodiments of the present disclosure are directed to a computer system for determining remediations for suspected threats. The computer system comprises: a computerized processor; and a non-transitory storage medium for storing instructions that, when executed by the computerized processor, cause the system to: obtain security data representing a suspected threat to a client, extract a plurality of technical features for the suspected threat from the security data, classify, by a first trained machine learning model, an authenticity of the suspected threat based on the plurality of technical features, estimate, by a second trained machine learning model, an impact on the client of addressing the suspected threat based on the plurality of extracted technical features, and determine, by a third trained machine learning model, a remediation for the suspected threat based on the authenticity classification and the estimated impact.

Embodiments of the present disclosure are directed to a computer usable non-transitory storage medium having a computer program embodied thereon for causing a suitably programmed system to determine remediations for suspected threats by performing the following steps when such program is executed on the system, the steps comprising: obtaining security data representing a suspected threat to a client; extracting a plurality of technical features for the suspected threat from the security data; classifying, by a first trained machine learning model, an authenticity of the suspected threat based on the plurality of technical features; estimating, by a second trained machine learning model, an impact on the client of addressing the suspected threat based on the plurality of extracted technical features; and determining, by a third trained machine learning model, a remediation for the suspected threat based on the authenticity classification and the estimated impact.

Unless otherwise defined herein, all technical and/or scientific terms used herein have the same meaning as commonly understood by one of ordinary skill in the art to which the disclosure pertains. Although methods and materials similar or equivalent to those described herein may be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present disclosure are herein described, by way of example only, with reference to the accompanying drawings. With specific reference to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

Attention is now directed to the drawings, where like reference numerals or characters indicate corresponding or like components. In the drawings:

FIG. 1 is a flow diagram illustrating a method for determining remediations for suspected threats, according to embodiments of the present disclosure;

FIG. 2 is a data flow diagram according to embodiments of the present disclosure; and

FIG. 3 is a diagram of an architecture of an exemplary system according to an embodiment of the present disclosure.

### DESCRIPTION OF THE PREFERRED EMBODIMENTS

The present disclosure is directed to systems, methods, and computer program products for, among other things, determining remediations for suspected threats.

Before explaining at least one embodiment of the disclosure in detail, it is to be understood that the disclosure is not necessarily limited in its application to the details of construction and the arrangement of the components and/or methods set forth in the following description and/or illustrated in the drawings and/or the examples. The disclosure is capable of other embodiments or of being practiced or carried out in various ways.

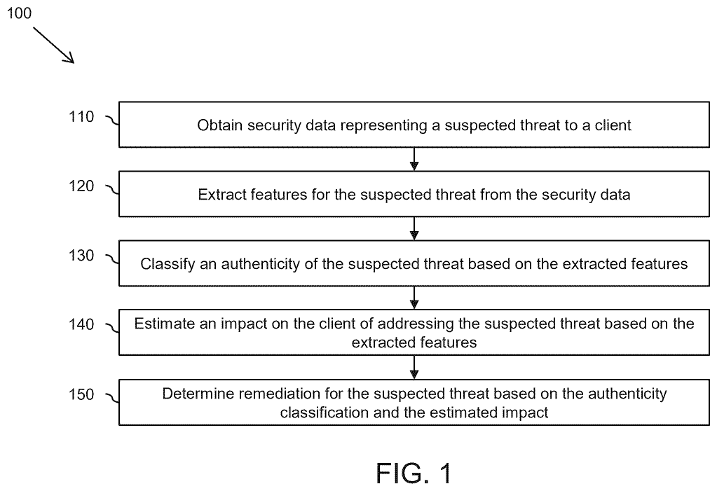

Referring now to the drawings, reference is made to FIG. 1, which illustrates a flow diagram of a computer-implemented method 100, in accordance with some exemplary embodiments of the disclosed subject matter. This computer-implemented method includes an algorithm for, among other things, determining remediations for suspected threats. The method (i.e., its steps and sub-steps) are for example, performed automatically, but can be, for example, performed manually, and are performed, for example, in real time.

At step 110, security data representing a suspected threat to a client may be obtained, and optionally pre-processed.

In some exemplary embodiments, security data may be extracted from security systems of the client, such as various systems, tools, applications, network devices, or the like, employed by the client to address security threats on its digital assets. For example, the security data may be obtained from Security Information and Event Management (SIEM) Systems of a client, from cloud storage services, from log analytics services, from on-premises log servers, from syslog servers, from log management tools, from third-party security providers of the client, or the like.

In certain exemplary embodiments, the security systems may be configured to protect digital assets of the client, such as a software application, a web-based application, a desktop application, a cloud-based application, firmware code, a database system, a software package, a software module, or any other digital asset of the client, from threats, such as exploitations of vulnerabilities of the digital assets, attacks, or the like. In some exemplary embodiments, the security systems may be configured to generate security logs such as IPS logs associated with digital products of a client.

In some exemplary embodiments, the security data may comprise the security logs that reflect the suspected threat, other security logs, system logs, configuration files, configuration settings, or the like. In some exemplary embodiments, the security data may reflect security countermeasures taken by the security systems in response to identifying a suspected threat. In some exemplary embodiments, the security logs may represent a suspected threat, and one or more remediations performed by security systems of the client in response to identifying the suspected threat. For example, the security logs may represent a blocked threat, a reported threat that is not blocked, or the like. In some exemplary embodiments, the security data may reflect actual threats, or false positive identifications of threats. For example, the client data may reflect an attempt of a threat actor to exploit a vulnerability of a digital asset. In some exemplary embodiments, the security data may be provided per application, for all client applications, or the like.

In certain exemplary embodiments, the security logs may comprise IPS logs, firewall logs tracking inbound and outbound traffic, AntiBot logs, AntiVirus logs, Virtual Private Network (VPN) logs recording remote access sessions and authentication attempts, Endpoint Detection and Response (EDR) logs, network access logs recording details about network connections and access attempts, web proxy logs, cloud security logs documenting network activity within cloud environments, Zero Trust Network Access (ZTNA) logs, switch and router logs, or the like. For example, cloud security logs may comprise Amazon™ Web Services (AWS) Virtual Private Cloud (VPC) Flow Logs, Azure™ Network Security Group (NSG) Flow Logs, or the like. As another example, network access logs may record data such as source and destination Internet Protocol (IP) addresses, ports, timestamps, user identities, connection status (e.g., allowed or blocked), protocols used, or the like.

In some exemplary embodiments, in addition to security logs, the security data may comprise configuration files of a client. For example, configuration files may reflect the state of an execution platform of the client, settings of client devices or end devices that execute the client's system, time parameters associated with security logs such as a frequency of receiving security logs, or the like.

In certain exemplary embodiments, a security logs analysis may be carried out by an analysis platform that operates independently from the client's security systems, and is external therefrom. For example, in case the client employs a software firewall to protect their digital assets, the analysis platform may function externally to the firewall. According to this example, the analysis platform may be viewed as a user from the firewall's perspective. In some exemplary embodiments, the analysis platform may be executed on a same execution environment as the security systems, on a remote environment such as a server of the analysis platform, or the like.

In some exemplary embodiments, the security logs analysis may obtain and process the security data from the security systems of the client, e.g., as part of a preprocessing stage. For example, the security data may be extracted from third-party security systems of a client to which the analysis platform provided by the disclosed subject matter has no direct access, functions independently therefrom, or the like.

In certain exemplary embodiments, the security logs analysis may process the security data by accumulating security logs into events associated with respective threats. For example, an event may be correlated to a suspected threat identified by one or more security systems, and one or more types of remediations that were used by the security systems for addressing the suspected threat, time windows of the identified threats and their remediations, types of IP addresses of the threat, associated client assets, or the like.

In some exemplary embodiments, security logs may be aggregated to create a comprehensive dataset for analysis that captures different events, event metadata, common attack patterns, signatures, or the like. For example, aggregating security logs from multiple security systems and timeframes may provide an accurate picture of potential threats, relationships between events, or the like. In some exemplary embodiments, the event metadata may comprise security events occurring at various timestamps, an event source such as an address of a device that triggered the event, an event destination such as an address of a destination device, or the like, identifiable within the aggregated dataset. For example, each security log may be analyzed within a weeklong time window, or any other time window, leading up to its occurrence.

In certain exemplary embodiments, similar events may be accumulated to identify patterns of suspected threats, patterns of countermeasures taken by the security systems in response to detected suspected threats, their impact on the client, or the like. In some exemplary embodiments, aggregating logs over time enables identification of trends, anomalies, or the like for different events. For example, a series of failed login attempts over several hours might indicate a brute-force attack, and aggregation helps to spot such patterns more easily.

At step 120, for each suspected threat, features may be extracted from the accumulated logs or other security data (i.e., the obtained security data or the pre-processed security data) that reflect the suspect threat. For example, features may be extracted for a suspected threat based on individual events reflecting the threat, single logs, aggregated logs over a defined timeframe, or the like. In some exemplary embodiments, the aggregated dataset may be processed to engineer features that can be used as model inputs for the authenticity model, the impact model, or the like. For example, in case the security systems of the client comprise a firewall, at least one log or event of the aggregated dataset may be processed to extract a plurality of features, e.g., one or more of the following:
I. Firewall Vendor: a categorical feature representing discrete categories of a firewall vendor (or any other security system) reflected by the log, such as Check Point™, Fortinet™, Palo Alto Networks (PAN)™, or the like.
II. Direction of Connection: a categorical feature representing discrete categories of the connection direction of the inspected log. The possible categories of the “Direction of Connection” feature may include “internal-internal”, “internal-external”, “external-internal”, or the like, in which the first item of the pair refers to the source address of a packet and the second item refers to the destination address.
III. Protection Confidence: a normalized integer parameter that may be standardized across various vendors. For example, this feature may represent the level of confidence in the effectiveness of security countermeasures taken by a respective firewall or other security system employed by the client, to address a suspected threat reflected by the log.
IV. Protection Severity: a normalized integer parameter that may be standardized across various vendors. For example, this feature may represent the severity of a potential threat such as a security event reflected by the log.
V. Number of Logs with the Same Direction-Protection Combination: an integer parameter that counts a number of logs (in the aggregated dataset) with the same direction-protection combination as the inspected log.
VI. Number of Logs with the Same Source-Destination IP Addresses Combination: an integer parameter that counts a number of logs (in the aggregated dataset) sharing the same source-destination IP address combination as the inspected log.
VII. Number of Suppressed Logs with the Same Direction-Protection Combination: an integer parameter that counts a number of suppressed logs (in the aggregated dataset) sharing the same direction-protection combination as the inspected log.
VIII. Number of Suppressed Logs with the Same Source-Destination IP Addresses Combination: an integer parameter that counts a number of suppressed logs (in the aggregated dataset) sharing the same source-destination IP address combination as the inspected log.
IX. Number of Unique Destination IP Addresses for the Same Direction-Protection Combination: an integer parameter that counts a number of distinct destination IP addresses in logs of the aggregated dataset, sharing the same direction-protection combination as the inspected log.
X. Number of Unique Protections for the Destination IP Address: an integer parameter that counts a number of distinct protections associated with the destination IP address of the inspected log.
XI. Number of Unique Source IP Address Classes for the Destination IP Address: an integer parameter that counts a number of distinct source IP address classes associated with the destination IP address of the inspected log.
XII. Earliest Year of Protection: an integer parameter that stores the earliest year associated with the protection of the inspected log.
XIII. Latest Year of Protection: an integer parameter that stores the latest year associated with the protection of the inspected log.
XIV. Number of Unique Source IP Addresses for the Same Direction-Protection Combination: an integer parameter that counts a number of distinct source IP addresses in logs of the aggregated dataset, sharing the same direction-protection combination as the inspected log.
XV. Mean Time Deltas Between Consecutive Logs: a floating point parameter that measures the mean time difference, or delta, between consecutive logs of the aggregated dataset that share the same direction-protection combination as the inspected log. For example, the relationship between the mean time delta and the mean frequency of events may be represented as following:

$$mean time delta = ( \frac{1}{Mean Frequency} ) \qquad ( 2 )$$

The mean time deltas may be calculated as following:

$$\overline{Δ t} = \frac{1}{N - 1} {\sum }_{i = 2}^{N} ( {t}_{i} - {t}_{i - 1} ) \qquad ( 3 )$$

where Δ̅t̅ is the mean-time deltas, N is the number of logs of the aggregated dataset that share the same direction-protection combination, tᵢ is the timestamp of the i^{th} log, tᵢ₋₁ is the timestamp of the previous log, and tᵢ-tᵢ₋₁ is the time difference between consecutive logs.
XVI. Standard Deviation of Time Deltas Between Consecutive Logs: a floating point parameter that measures the standard deviation of time differences between consecutive logs sharing the same direction-protection combination as the inspected log, normalized by the mean value. The parameter may be calculated as following:

$${σ}_{Δ t} = \frac{\sqrt{\frac{1}{N - 1} {\sum }_{i = 2}^{N} {( ( {t}_{i} - {t}_{i - 1} ) - \overline{Δ t} )}^{2}}}{\overline{Δ t}} \qquad ( 4 )$$

where σ_{Δt} is the standard deviation of time deltas between consecutive logs, Δ̅t̅ is the mean-time deltas, N is the number of logs of the aggregated dataset that share the same direction-protection combination, tᵢ is the timestamp of the i^{th} log, tᵢ₋₁ is the timestamp of the previous log, and tᵢ-tᵢ₋₁ is the time difference between consecutive logs.
XVII. Percentage of Outliers in Time Deltas Between Consecutive Logs: a floating point parameter that measures the proportion of time deltas between consecutive logs flagged as outliers, in logs sharing the same direction-protection combination as the inspected log. For example, outlier data points may be calculated using Poincaré plots, statistical methods such as Z-scores or box plots (IQR), Mahalanobis distance, Grubbs' test, or any other technique.
XVIII. Connection on Weekend: a binary feature indicating whether the connection represented by the log occurred on a weekend (′1′ for yes, ‘0’ for no, or vice versa).
XIX. Protection with Mixed Directions: a binary feature indicating whether the protection that was used against the suspected threat, as reflected by the log, is associated with mixed connection directions (′1′ for yes, ‘0’ for no, or vice versa).

In other cases, any other features, alone or in combination of the above features, may be generated for each suspected threat. For example, in case the client uses an Antivirus security system instead of a firewall, the “Firewall Vendor” feature may be replaced with a “Antivirus Vendor” feature. In some cases, features may be extracted from at least one security log, within a time window.

In some exemplary embodiments, one or more of the exemplary features may be challenging to extract from the aggregated dataset or portion thereof. For example, the “Direction of Connection” feature may be challenging to extract from the security logs, since traditional security systems may not be capable of differentiating between communications that are internal, communications that exit the client's system to an external entity, and communications that enter the client's system from an external entity. In some exemplary embodiments, without differentiating between internal and external communications, it may be impossible to classify the directions of a communication reflected by one or more security logs.

In some cases, analyzing IP addresses of packets that are communicated to and from the client's system may not necessarily enable to differentiate between internal and external communications, at least since addresses that appear public might actually be used for internal communication within an organization, while some private addresses might be used in a way that resembles public communication. For example, large organizations may assign public IP addresses for internal use, making it challenging to classify traffic solely based on address format.

For example, a programmer may set up or deploy a server within a cloud such as Amazon Web Services (AWS), and may communicate from the server to the backend of the client's system. In this scenario, the communication originating from the programmer will be classified by security systems of the client as external communications that enter the client's system from an external entity, likely causing the communication to be blocked by the security systems.

According to certain aspects, the present disclosure generates a topology of the client's digital assets, that maps or classifies IP addresses used by the client as external or internal. In some exemplary embodiments, interfaces and routing configuration(s) of the client's digital assets may be processed to generate the topology, automatically or manually. In some cases, users of the client, such as administrator users, may be requested to confirm the generated topology, such as in case it is automatically generated.

In certain exemplary embodiments, using the topology, the disclosed subject matter enables the extraction of the “Direction of Connection” feature from the security logs. For example, using the topology, a security log representing a packet may be preprocessed to extract a classification of the packet as entering the client's system, exiting the client's system, or staying internally to the client's system.

As an example, a security log may reflect a communicated packet between a first IP address and a second IP address. In view of the generated topology, the first and second addresses may be classified as internal or external addresses. The results may range from the first IP address being internal and second IP address external, both IP addresses being internal, to the first IP address being external and second IP address internal.

Referring back to the above example, in case the programmer communicates from the AWS server to the backend of the client's system, the generated topology may map the AWS address as an internal address. In such cases, the “Direction of Connection”, feature may be determined to be “internal-internal”, causing the decision of the client's security system to block the communication to be reversed by the analysis platform.

In some exemplary embodiments, the analysis platform may deploy one or more artificial intelligence models, machine learning models, algorithms, or the like, to process the extracted features. In some exemplary embodiments, each model of the analysis platform may be exploited, utilized, fine-tuned, or the like, for a respective task. For example, a first model may be tasked with classifying the suspected threat as authentic or not, and the second model may be tasked with scoring an impact of each suspected threat, e.g., as described in steps 130 and 140 of method 100.

At step 130, the analysis platform may utilize a first model, referred to as the authenticity model, in order to classify suspected threats as authentic threats or not. In some exemplary embodiments, the authenticity model may comprise a single classifier, an ensemble of classifiers, or the like. In some exemplary embodiments, the authenticity model may be trained to distinguish between legitimate attacks and benign events, such as in order to minimize false positives and reduce alert overload.

In certain exemplary embodiments, the authenticity model may comprise one or more supervised or semi-supervised machine learning classifiers, predictors, algorithms, or the like. In some exemplary embodiments, the authenticity model may be trained on a labeled dataset of events (derived from aggregated security logs) labeled as legitimate attacks or as benign events. In some exemplary embodiments, the dataset may comprise historical aggregated security logs, each labelled as a legitimate attack or as a benign event. For example, the dataset may be labeled manually, automatically, may be obtained from a third party, or the like.

In some exemplary embodiments, after the training phase, the authenticity model may be configured to obtain events, or one or more security logs reflecting a suspected threat, and to classify the suspected threat into one or more classes, such as a false positive class, a true positive class, an unknown class, a scanner class, or the like. For example, the false positive class may indicate a benign event misclassified as a threat, while the true positive class may indicate a confirmed malicious attack. In some cases, the unknown class may indicate that the suspected threat requires further analysis, such as in case the confidence score of the classification is less than a threshold (e.g., set by the user). In some cases, the scanner class may indicate an automated reconnaissance activity, e.g., an activity of a tool or script that automatically collects information to prepare for a potential attack.

In certain exemplary embodiments, in order to differentiate between authentic threats and benign events, the authenticity model may be configured to generate, as output, a probability vector indicating the likelihood of the suspected threat to belong to one or more classes, to all the above classes, or the like. For example, the authenticity model may generate a probability vector for each of the classes. In some exemplary embodiments, one class may be selected to represent the suspected threat. For example, the class with the highest probability may be selected as the classification of the suspected threat.

As an example, the authenticity model may obtain one or more features that are extracted from the aggregated dataset, and reflect a suspected threat, such as valuations of features I-XIX, as described above. For example, the extracted features may comprise features such as Firewall Vendor, Direction of Connection, Protection Confidence, Protection Severity, Number of Logs with the Same Direction-Protection Combination, Number of Logs with the Same Source-Destination IP Addresses Combination, Number of Suppressed Logs with the Same Direction-Protection Combination, Number of Suppressed Logs with the Same Source-Destination IP Addresses Combination, Number of Unique Destination IP Addresses for the Same Direction-Protection Combination, Number of Unique Protections for the Destination IP Address, Number of Unique Source IP Address Classes for the Destination IP Address, Earliest Year of Protection, Latest Year of Protection, Protection with Mixed Directions, Connection on Weekend, Percentage of Outliers in Time Deltas Between Consecutive Logs, Standard Deviation of Time Deltas Between Consecutive Logs, Mean Time Deltas Between Consecutive Logs, Number of Unique Source IP Addresses for the Same Direction-Protection Combination, or the like.

In some exemplary embodiments, the valuations of the features may be identified, for each suspected threat, and provided to the authenticity model. Table 1 below is an example of exemplary valuations of features that may be provided to the authenticity model.

TABLE 1

| | |
|---|---|
| Firewall Vendor | ‘CP’ |
| Direction of Connection | ‘int-int’ |
| Protection Confidence | 1 |
| Protection Severity | ‘critical’ |
| Number of Logs with the Same | 145 |
| Direction Protection Combination | |
| Number of Logs with the Same | 6 |
| Source-Destination IP Addresses | |
| Combination | |
| Number of Suppressed Logs with | 229 |
| the Same Direction-Protection | |
| Combination | |
| Number of Suppressed Logs with | |
| the Same Source-Destination | |
| Combination | |
| Number of Unique Destination IP | 2 |
| Addresses for the Same Direction- | |
| Protection Combination | |
| Number of Unique Protections for | 4 |
| the Destination IP Address | |
| Earliest Year of Protection | 2012 |
| Latest Year of Protection | 2012 |
| Number of Unique Source IP | 25 |
| Addresses for the Same Direction- | |
| Protection | |
| Combination | |
| Mean Time Deltas Between | 0.86 |
| Consecutive Logs | |
| Standard Deviation of Time Deltas | 1.6 |
| Between Consecutive Logs | |
| Percentage of Outliers in Time | 6 |
| Deltas | |
| Between Consecutive Logs | |
| Protection with Mixed Directions | ‘yes’ |

In some exemplary embodiments, the authenticity model may process the obtained values of the extracted features, such as the values exemplified in Table 1, and generate a probability vector indicating the likelihood of the suspected threat of belonging to one or more classes. For example, the authenticity model may classify the suspected threat as a false positive class, a true positive class, an unknown class, or a scanner class. Table 2 below is an example of a classification output by the authenticity model based on the values exemplified in Table 1.

TABLE 2

| | |
|---|---|
| False Positive | 0.9963 |
| Unknown | 0.0013 |
| Scanner | 0.0007 |
| True Positive | 0.0017 |

As depicted in Table 2, in the exemplified case, the authenticity model classified the suspected threat as having a highest probability of being a “False Positive” benign event that is not an authentic threat. For example, the classification of the logs or events that represent the suspected threat to the “False Positive” class may comply with a confidence threshold, e.g., an 80% threshold, may be higher than other classification scores of other classes, or the like. In some cases, the classification into the “False Positive” class may rely at least in part on the Direction of Connection parameter indicating that the communication is internal (′int-int′), which may indicate that the communication is likely legitimate and not an authentic threat.

In some exemplary embodiments, in other exemplary cases, different valuations of the features may be identified, for a suspected threat, and provided to the authenticity model. Table 3 below is another example of exemplary valuations of features that may be provided to the authenticity model.

TABLE 3

| | |
|---|---|
| Firewall Vendor | ‘CP’ |
| Direction of Connection | ‘ext-int’ |
| Protection Confidence | 3 |
| Protection Severity | ‘critical’ |
| Number of Logs with the Same | 93 |
| Direction-Protection Combination | |
| Number of Logs with the Same | 4 |
| Source-Destination IP Addresses | |
| Combination | |
| Number of Suppressed Logs with | 131 |
| the Same Direction-Protection | |
| Combination | |
| Number of Suppressed Logs with | 4 |
| the Same Source-Destination IP | |
| Addresses | |
| Combination | |
| Number of Unique Destination IP | 5 |
| Addresses for the Same Direction- | |
| Protection Combination | |
| Number of Unique Protections for | 16 |
| the Destination IP Address | |
| Earliest Year of Protection | 2016 |
| Latest Year of Protection | 2016 |
| Number of Unique Source IP | 57 |
| Addresses for the Same Direction- | |
| Protection | |
| Combination | |
| Mean Time Deltas Between | 1.82 |
| Consecutive Logs | |
| Standard Deviation of Time Deltas | 1.21 |
| Between Consecutive Logs | |
| Percentage of Outliers in Time | 4 |
| Deltas Between Consecutive Logs | |
| Protection with Mixed Directions | No |
| . . . | |

In some exemplary embodiments, the authenticity model may process the obtained values of the extracted features, as exemplified in Table 3, and generate a probability vector indicating the likelihood of the suspected threat belonging to one or more classes. For example, the authenticity model may classify the suspected threat as a false positive class, a true positive class, an unknown class, or a scanner class. Table 4 below is an example of a classification output by the authenticity model based on the values exemplified in Table 3.

TABLE 4

| | |
|---|---|
| False Positive | 0.0098 |
| Unknown | 0.0009 |
| Scanner | 0.0001 |
| True Positive | 0.9892 |

As depicted in Table 4, in the exemplified case, the authenticity model classified the suspected threat differently from the classification of Table 2. For example, in the exemplified case, the authenticity model classified the suspected threat as having a highest probability of being a “True Positive” authentic threat that poses a real threat to the digital assets. For example, the classification of the logs or events that represent the suspected threat to the “True Positive” class may comply with a confidence threshold e.g., an 80% threshold, may be higher than other classification scores of other classes, or the like.

In some cases, the classification into the “True Positive” class may rely at least in part on the Direction of Connection parameter indicating that the communication is external (′ext-int′), which may increase the chance that the communication is an authentic threat.

At step 140, the analysis platform may utilize a second model, referred to as the impact model, in order to score an estimated impact of addressing the suspected threat on the client. In some exemplary embodiments, the impact model may comprise an ensemble of one or more supervised or semi-supervised regression models, trained to score or evaluate an impact of blocking a suspected threat on a client. For example, the impact may be estimated with respect to critical client processes, to client assets, to business workflows of the client, or the like.

In certain exemplary embodiments, the impact model may be trained on a labeled dataset of events, such as the dataset of step 130, a dataset with features I-XIX, on configuration files of clients, values of different digital assets of a client, a cost of various remediations, downtime consequences, a number of affected devices, or the like. In some exemplary embodiments, the dataset may comprise events, or security logs, labeled with a corresponding impact score, such as on a scale of 1 to 10 or any other scale. For example, the impact dataset may be initially labeled manually, and then using the manual labels, labeled automatically. As another example, the impact dataset may be obtained from a remote server. In some exemplary embodiments, during the training phase, the model may learn relationships between variables such as security logs and estimate outcomes such as business impacts.

In some exemplary embodiments, the impact model may simulate the business impact of responding to the suspected threat, such as by blocking communications related to the potential threat, blocking the data flow, reporting the suspected threat, or the like. In some exemplary embodiments, the impact model may be configured to generate classification labels that predict, based on the input, numerical values or scores representing the impact. For example, the values may be normalized. In some exemplary embodiments, the classification labels may be generated for suspected threats, regardless of whether the security systems of the client blocked the threat or not. For example, for the purpose of estimating the impact of blocking a suspected threat on a client, the impact model may assume that all inputted suspected threats were blocked by the security systems of the client, even if they were not.

In some exemplary embodiments, the impact model may be trained to predict, during the inference stage, an estimated impact of a newly obtained log or event. In some exemplary embodiments, after the training phase, the impact model may be configured to obtain events, or one or more security logs reflecting a suspected threat, and to score an estimated impact of blocking the suspected threat. The scores may range from a scale of 1 to 10, from 1 to 5, or follow any other predefined scales, depending on the configuration and use case. For example, a value of 1 may represent a lowest impact score, and a value of 10 may represent a highest impact score.

In some exemplary embodiments, since impacts of protection operations implemented by security systems may differ between clients, the impact model may be customized for different clients, such as by training it on client-specific weights or cost functions, implementing a feedback loop, or the like. For example, a feedback loop may be implemented during the training phase or the inference phase of the model, and may obtain from users of a client indications of whether the impact score was accurate, too high, or too low, enabling to re-train the model to adjust its weights accordingly. In some exemplary embodiments, the feedback loop may be implemented per client, or averaged over a plurality of clients. In some exemplary embodiments, different impact models may be trained per client category. For example, different impact models may be provided for clients based on their size, their field of industry, or the like.

As an example, in case a client is a sperm donation company that maintains a database of sperm donations, and one or more packets querying the database are flagged as a suspected threat, the client's firewall may block access to the entire database. According to this example, the impact on the client may be significant, as it would prevent any buyers from purchasing sperm donations. In other cases, if a database that is not central to the client's core business is blocked, the impact may be less severe, resulting in an assignment of a lower score.

At step 150, the analysis platform may utilize a third model, referred to as the analyzer model, in order to determine a remediation for the suspected threat. In some exemplary embodiments, the analyzer model may comprise an ensemble of one or more supervised or semi-supervised RL models, configured to obtain outputs from the authenticity and impact models, e.g., from steps 130 and 140, and determine based thereon a priority score of the suspected threat. In case of high priority threats, a remediation for the suspected threat may be generated. For example, the remediation may comprise blocking the suspected threat, releasing a blocking of the suspected threat, or the like.

In some exemplary embodiments, the analyzer model may assign a risk level to the suspected threat, assign a priority score to the suspected threat, apply the determined remedial action (e.g., using the software agent), or the like. For example, the priority score or risk level may be assigned based on outputs of the authenticity and impact models, weights applied thereto, heuristic rules, client-specific rules such as business logic, client constraints, client settings, client customizations, or the like. In some exemplary embodiments, the analyzer model may apply one or more weights on the outputs of the authenticity and impact models, such as to obtain a weighted average of the classification result and of the impact score. In some exemplary embodiments, based on the weighted average, the analyzer model may determine the priority score of the suspected threat.

In some exemplary embodiments, alerts and/or reports may be generated for high-priority threats, such as threats that comply with a threshold, while filtering out lower scoring threats. In some exemplary embodiments, a proper remediation to the suspected threat, such as blocking the suspected threat, releasing a blocking that was performed by the security systems, retaining the current settings of the security systems, or the like, may be generated for high-priority threats. For example, the remediation may be incorporated into an alert or report.

In certain exemplary embodiments, the determined remediation may comprise a determined policy change for one or more environments, devices, services, or the like, of the client. For example, the determined remediation may comprise an instruction to adjust configurations or settings of the client system. For example, in case a current configuration of a client is set to block a certain type of suspected threat, the recommendation may indicate to change the configuration so that future threats will be reported without blocking data communications. As another example, in case a current configuration of a client is set to report a certain type of suspected threat without blocking it, the recommendation may indicate to change the configuration so that future threats will be blocked. As another example, in case a current configuration of a client is determined to be the optimal or recommended setting, a recommendation to keep the current settings may or may not be generated.

In some exemplary embodiments, the determined remediation may be provided in the form of reports, alerts, automatic remediations, security recommendations, a responsive action, one or more security decisions, or the like.

In certain exemplary embodiments, the analyzer model may be configured to improve its priority scores and recommendations over time, according to preferences of each client. In some exemplary embodiments, the RL models may be configured to implement a feedback loop in order to tailor the authenticity and impact models specifically to the client through active learning training, e.g., as described above.

Steps 130-150 may be performed iteratively, such as for various suspected threats that are detected by security systems of each client.

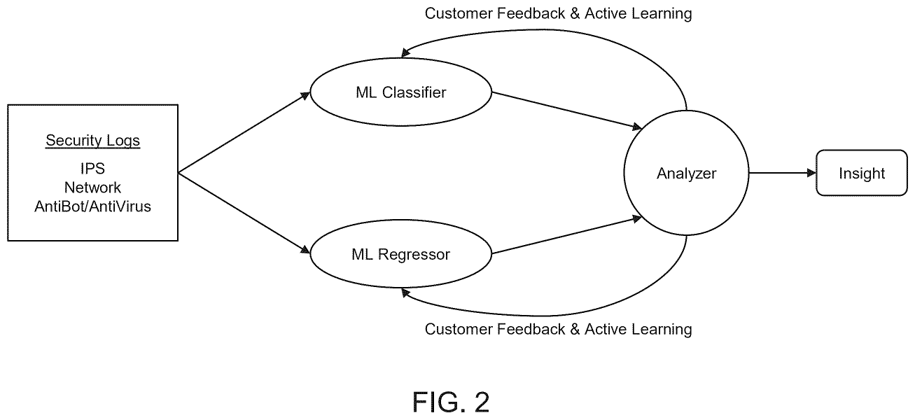

With continued reference to FIG. 1, refer now also to FIG. 2, which illustrates a data flow diagram, in accordance with some exemplary embodiments of the disclosed subject matter.

As depicted in FIG. 2, security logs of a client may be obtained (for example as part of step 110 of method 100). Such security logs may comprise IPS logs, Network logs, Antibot logs, Antivirus logs, or the like. In some exemplary embodiments, the security logs may be processed (for example as part of step 120 of method 100), such as to aggregate them into events and extract features therefrom.

In some exemplary embodiments, the security logs and/or derived features therefrom may be fed, as input, to the authenticity and impact models. For example, security logs that reflect a certain threat may be fed to the authenticity and impact models, alone or in combination with additional data such as configuration settings of the client.

As further depicted in FIG. 2, the authenticity model may be implemented by one or more trained ML classifiers, and the impact model may be implemented by one or more trained ML regressors. In some exemplary embodiments, the analyzing model may be implemented by one or more RL models. In other cases, any other types of models may be used.

In some exemplary embodiments, the authenticity model may output (for example as part of step 130 of method 100) a classification of the authenticity of the suspected threat to the analyzing model, and the impact model may output (for example as part of step 140 of method 100) a score of an impact of applying security countermeasures against the suspected threat. The classification and impact score may be provided to the analyzing model.

In some exemplary embodiments, the analyzing model may generate (for example as part of step 150 of method 100), based on the impact score and the authenticity classification, an insight indicating a recommendation to block the event, to enable the event, or to maintain the current settings of the security systems. In some exemplary embodiments, a feedback loop may enable to personalize the models for each client over time, such as using active learning training.

The present disclosed subject matter may be a system, a method, and/or a computer program product. The computer program product may include a computer readable storage medium (or media) having computer readable program instructions thereon for causing a processor to carry out aspects of the present disclosed subject matter.

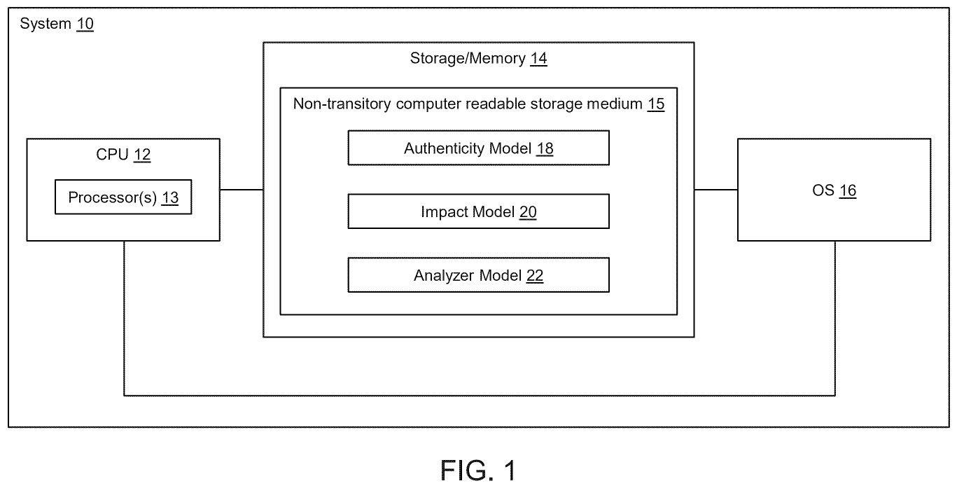

FIG. 3 illustrates an exemplary architecture of a system 10 embodying the analysis platform, according to an embodiment of the present disclosure. The system 10 is configured to execute the methods (e.g., 100) of the present disclosure. The system 10 includes a central processing unit (CPU) 12, a storage/memory 14, and an operating system (OS) 16. The CPU 12 is formed from one or more computerized processors 13. The processor(s) 13 can, for example, be conventional processors, such as those used in servers, computers, and other computerized devices. For example, the processor(s) 13 may include x86 Processors from AMD and Intel, Xeon® and Pentium® processors from Intel, as well as any combinations thereof.

The CPU 12 is electronically coupled (connected) to the storage/memory 14, which is configured for storing machine executable instructions, executable by the processor(s) 13 of the CPU 12, for causing the system 10 to execute the methods (e.g., 100) of the present disclosure, as described in detail above. The storage/memory 14, although shown as a single component for representative purposes, may be multiple components. Preferably at least one of the components of the storage/memory 14 is in the form of a non-transitory computer readable storage medium which stores the aforementioned models (for example as computer modules). In the illustrated embodiment, a non-transitory computer readable storage medium 15 of the storage/memory 14 stores the authenticity model 18, the impact model 20, and the analyzer model 22. The non-transitory computer readable storage medium 15 may also store additional modules for executing other functions of the present disclosure. The CPU 12 is further electronically coupled (connected) to OS 16, which may load machine executable instructions, stored in the storage/memory 14, for execution by the CPU 12. The OS 16 may include any of the conventional computer operating systems, such as those available from Microsoft of Redmond Washington, commercially available as Windows® OS, such as Windows® 10, Windows® 7, MAC OS from Apple of Cupertino, CA, or Linux, or may include real-time operating systems.

The computer readable storage medium (e.g., 15) can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description, but is not intended to be exhaustive or limited to the disclosed subject matter in the form disclosed. Many modifications and variations will be apparent to those of ordinary skill in the art without departing from the scope and spirit of the disclosed subject matter. The embodiments were chosen and described in order to best explain the principles of the disclosed subject matter and the practical application, and to enable others of ordinary skill in the art to understand the disclosed subject matter for various embodiments with various modifications as are suited to the particular use contemplated.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the invention.

What is claimed is:

1. A computer-implemented method for determining remediations for suspected threats, the method comprising:
obtaining security data representing a suspected threat to a client;
extracting a plurality of technical features for the suspected threat from the security data;
classifying, by a first trained machine learning model, an authenticity of the suspected threat based on the plurality of technical features;
estimating, by a second trained machine learning model, an impact on the client of addressing the suspected threat based on the plurality of extracted technical features; and
determining, by a third trained machine learning model, a remediation for the suspected threat based on the authenticity classification and the estimated impact.

2. The method of claim 1, wherein the plurality of technical features includes a Direction of Connection feature.

3. The method of claim 2, wherein the Direction of Connection feature is determined by generating a topology of digital assets of the client.

4. The method of claim 1, wherein the plurality of technical features includes at least one of: a Protection Confidence parameter, a Protection Severity parameter, a Number of Logs with a same direction-protection combination, a Number of Unique Destination IP Addresses for a same direction-protection combination, a Mean Time Deltas between consecutive logs, a Standard Deviation of Time Deltas between consecutive logs, or a Percentage of Outliers in time deltas.

5. The method of claim 4, wherein the Mean Time Deltas between consecutive logs is calculated by dividing a sum of time differences between consecutive logs by a number of logs.

6. The method of claim 4, wherein the plurality of technical features includes a Standard Deviation of Time Deltas between consecutive logs and a Percentage of Outliers in time deltas.

7. The method of claim 1, wherein the security data is obtained from one or more security systems of the client, the one or more security systems including at least one of an Intrusion Prevention System (IPS), a firewall, an AntiBot system, an AntiVirus system, or a Security Information and Event Management (SIEM) system.

8. The method of claim 1, wherein obtaining the security data includes aggregating security logs of the client into events.

9. The method of claim 1, further comprising: processing the obtained security data to identify the suspected threat, and wherein extracting the plurality of technical features for the suspected threat is performed on the processed security data.

10. The method of claim 1, wherein the third trained machine learning model is configured to apply one or more weights on the authenticity classification and the estimated impact.

11. The method of claim 1, wherein the first trained machine learning model is a classifier that provides an authenticity classification as a probability vector.

12. The method of claim 1, wherein the second trained machine learning model is a regression model that provides the estimated impact as a normalized score.

13. The method of claim 1, wherein the first trained machine learning model is trained using a labeled dataset of events labeled as legitimate attacks or as benign events.

14. The method of claim 1, wherein the second trained machine learning model is trained using one or more of: a labeled dataset of events labeled as legitimate attacks or as benign events, extracted technical features from suspected threats, configuration files of clients, values of digital assets, remediation costs, downtime consequences, or a number of affected devices.

15. The method of claim 1, further comprising receiving feedback from the client and tailoring at least one of the trained machine learning models based on the feedback.

16. The method of claim 1, wherein the remediation comprises one of blocking the suspected threat or releasing a blocking of the suspected threat.

17. The method of claim 1, further comprising generating an alert or a report, wherein the remediation is incorporated into the alert or report.

18. The method of claim 1, wherein the third trained machine learning model determines a priority score for the suspected threat based on the authenticity classification and the estimated impact.

19. A computer system for determining remediations for suspected threats, the computer system comprising:
a computerized processor; and
a non-transitory storage medium for storing instructions that, when executed by the computerized processor, cause the system to:
obtain security data representing a suspected threat to a client,
extract a plurality of technical features for the suspected threat from the security data,
classify, by a first trained machine learning model, an authenticity of the suspected threat based on the plurality of technical features,
estimate, by a second trained machine learning model, an impact on the client of addressing the suspected threat based on the plurality of extracted technical features, and
determine, by a third trained machine learning model, a remediation for the suspected threat based on the authenticity classification and the estimated impact.

20. A computer usable non-transitory storage medium having a computer program embodied thereon for causing a suitably programmed system to determine remediations for suspected threats by performing the following steps when such program is executed on the system, the steps comprising:
obtaining security data representing a suspected threat to a client;
extracting a plurality of technical features for the suspected threat from the security data;
classifying, by a first trained machine learning model, an authenticity of the suspected threat based on the plurality of technical features;
estimating, by a second trained machine learning model, an impact on the client of addressing the suspected threat based on the plurality of extracted technical features; and
determining, by a third trained machine learning model, a remediation for the suspected threat based on the authenticity classification and the estimated impact.
